(19) United States
(12) Patent Application Publication
(10) Pub. No.: US 2025/0270971 A1
(43) Pub. Date: Aug. 28, 2025

(54) HYDROGEN FUEL SYSTEM, A HYDROGEN INTERNAL COMBUSTION ENGINE SYSTEM, AND A METHOD FOR OPERATING A HYDROGEN FUEL SYSTEM

(71) Applicant: CUMMINS INC., Columbus, IN (US)

(72) Inventors: Hemant Prakash Deshpande, Pune (IN); Virat Sethi, Pune (IN); Deepankar Tiwari, Balewadi (IN); Dhiraj Dattatray Kadam, Tal-Phaltan (IN); Ajay Khare, Pune (IN)

(73) Assignee: CUMMINS INC., Columbus, IN (US)

(21) Appl. No.: 19/062,931

(22) Filed: Feb. 25, 2025

(30) Foreign Application Priority Data
Feb. 26, 2024 (IN) 202441013666
Feb. 20, 2025 (IN) 20244101 3666

(51) Int. Cl. F02M 21/02; F02D 19/02

(52) U.S. Cl. CPC F02M 21/0242; F02D 19/023; F02M 21/0206

(57) ABSTRACT

A hydrogen fuel system includes a hydrogen fuel conduit, a hydrogen fuel rail, and a vent valve. The hydrogen fuel rail is in fluid communication with the hydrogen fuel conduit. The vent valve is in fluid communication with at least one of the hydrogen fuel conduit or the hydrogen fuel rail. The vent valve is configured to selectively transition between an open state and a closed state, the open state facilitating at least one of venting or purging of the hydrogen fuel system.

### CROSS-REFERENCE TO RELATED APPLICATIONS

This application claims priority to and the benefit of Indian Provisional Patent Application No. 202441013666, filed Feb. 26, 2024, and Indian Nonprovisional patent Application No. 202441013666, filed Feb. 20, 2025. The contents of these applications are incorporated by reference in its entirety.

### TECHNICAL FIELD

The present disclosure relates generally to hydrogen internal combustion engines.

### BACKGROUND

Hydrogen internal combustion engines combust air and hydrogen to produce power. These internal combustion engines may include a fuel system that leaks hydrogen into an environment surrounding the hydrogen internal combustion engine.

### SUMMARY

In some implementations, a hydrogen fuel system includes a hydrogen fuel conduit, a hydrogen fuel rail, and a vent valve. The hydrogen fuel rail is in fluid communication with the hydrogen fuel conduit. The vent valve is in fluid communication with at least one of the hydrogen fuel conduit or the hydrogen fuel rail. The vent valve is configured to selectively transition between an open state and a closed state, the open state facilitating at least one of venting or purging of the hydrogen fuel system.

In some implementations, a method for operating a hydrogen fuel system includes receiving a valve signal and responsive to receiving the valve signal, transmitting, to a component of the hydrogen fuel system, an opening signal that causes a vent valve of the hydrogen fuel system to transition from a closed state to an open state. The open state facilitates at least one of venting or purging of the hydrogen fuel system.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a block schematic diagram of a hydrogen internal combustion engine system, according to one embodiment;

FIG. 2 is a block schematic diagram of a hydrogen fuel system for a hydrogen internal combustion engine system, according to one embodiment;

FIG. 3 is a partial cross-sectional view of a vent valve for a hydrogen fuel system, according to one embodiment;

FIG. 4 is a partial cross-sectional view of another vent valve for a hydrogen fuel system, according to one embodiment;

FIG. 5 is a block schematic diagram of a hydrogen fuel system for a hydrogen internal combustion engine system, according to one embodiment; and

FIG. 6 is a block diagram of a method of operating a vent valve, according to one embodiment.

The foregoing and other features of the present disclosure will become apparent from the following description and appended claims, taken in conjunction with the accompanying drawings. Understanding that these drawings depict only several embodiments in accordance with the disclosure and are therefore, not to be considered limiting of its scope, the disclosure will be described with additional specificity and detail through use of the accompanying drawings.

### DETAILED DESCRIPTION

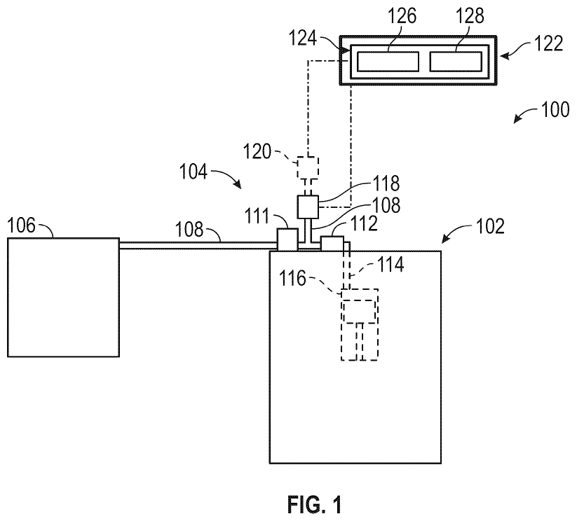

FIG. 1 depicts a hydrogen internal combustion engine system 100. The hydrogen internal combustion engine system 100 may be implemented in a vehicle (e.g., car, truck, construction vehicle, municipal vehicle, military vehicle, maritime vessel, etc.), generator (e.g., genset, etc.), or other similar engine-based application.

The hydrogen internal combustion engine system 100 includes a hydrogen fuel system 104. The hydrogen fuel system 104 includes a hydrogen fuel conduit 108, a hydrogen fuel rail 112, and a vent valve 118. The hydrogen fuel rail 112 is in fluid communication with the hydrogen fuel conduit 108. The vent valve 118 is in fluid communication with at least one of the hydrogen fuel conduit 108 or the hydrogen fuel rail 112. The vent valve 118 is configured to selectively transition between an open state and a closed state, the open state facilitating at least one of venting or purging of the hydrogen fuel system 104. The hydrogen internal combustion engine system 100 includes the hydrogen fuel system 104 and a hydrogen internal combustion engine 102. The hydrogen internal combustion engine 102 combusts hydrogen and fluid to produce power. The hydrogen fuel rail 112 is coupled to the hydrogen internal combustion engine 102.

In various embodiments, the hydrogen fuel system 104 includes the hydrogen fuel conduit 108, the hydrogen fuel rail 112 in fluid communication with the hydrogen fuel conduit 108, and the vent valve 118 in fluid communication with at least one of the hydrogen fuel conduit 108 or the hydrogen fuel rail 112. The vent valve 118 is configured to selectively transition between an open state and a closed state. The open state facilitates at least one of venting or purging of the hydrogen fuel system 104.

In various embodiments, a method for operating the hydrogen fuel system 104 includes receiving a valve signal and responsive to receiving the valve signal, transmitting, to a component of the hydrogen fuel system 104, an opening signal that causes the vent valve 118 of the hydrogen fuel system 104 to transition from the closed state to the open state. The open state facilitates at least one of venting or purging of the hydrogen fuel system 104.

In various embodiments, the hydrogen fuel system 104 also includes a compressed air pump 120 that is fluidly coupled to the vent valve 118 to facilitate operation of the vent valve 118. Specifically, the compressed air pump 120 is configured to selectively provide compressed air to the vent valve 118 to transition the vent valve 118 between the open state and the closed state. In various embodiments, the hydrogen fuel system 104 also includes a controller 122. The controller 122 is configured to cause the vent valve 118 to transition between the open state and the closed state. The controller 122 is communicable with at least one of the vent valve 118 or the compressed air pump 120. In various embodiments, the vent valve 118 is an electropneumatic valve.

The hydrogen fuel system 104 may additionally include an inert gas source (e.g., tank, etc.) that is configured to provide an inert gas (e.g., nitrogen, etc.) to the vent valve 118 to purge the hydrogen gas. This purging may be performed, for example, upon shutdown of the hydrogen internal combustion engine system 100.

The hydrogen fuel system 104 includes a hydrogen fuel source 106 (e.g., tank, etc.). The hydrogen fuel source 106 contains hydrogen (e.g., hydrogen fuel, etc.). The hydrogen fuel system 104 also includes a plurality of the hydrogen fuel conduits 108 (e.g., hydrogen fuel lines, etc.). At least one of the hydrogen fuel conduits 108 is fluidly coupled to the hydrogen fuel source 106 and is configured to receive the hydrogen from the hydrogen fuel source 106.

The hydrogen fuel system 104 also includes a pressure regulator 111 (e.g., low pressure regulator, etc.). The pressure regulator 111 is fluidly coupled to at least one of the hydrogen fuel conduits 108 and is configured to receive the hydrogen from the hydrogen fuel source 106 via at least one of the hydrogen fuel conduits 108. The pressure regulator 111 is configured to maintain a pressure of the hydrogen in the hydrogen fuel conduits 108 below a regulation pressure threshold. This regulation pressure threshold may be associated with maintained prolonged desirable operation of the hydrogen internal combustion engine system 100.

The hydrogen fuel system 104 also includes at least one of the hydrogen fuel rails 112. In some embodiments, the hydrogen fuel system 104 includes multiple of the hydrogen fuel rails 112. The hydrogen fuel rails 112 extend along portions of the hydrogen internal combustion engine 102 and deliver the hydrogen fuel to the hydrogen internal combustion engine 102.

The hydrogen fuel system 104 also includes at least one hydrogen fuel injector 114. Each of the hydrogen fuel injectors 114 is coupled to the hydrogen internal combustion engine 102 and at least one of the hydrogen fuel rails 112 and receives the hydrogen from the at least one of the hydrogen fuel rails 112. Each of the hydrogen fuel rails 112 is configured to provide the hydrogen to at least one of the hydrogen fuel injectors 114.

The hydrogen internal combustion engine 102 includes a plurality of cylinders 116. For example, the hydrogen internal combustion engine 102 includes 4, 6, 8, 10, 12, or other numbers of the cylinders 116. Additionally, the hydrogen internal combustion engine 102 includes a plurality of pistons. Each of the pistons is located within one of the cylinders 116. Each of the hydrogen fuel injectors 114 is configured to provide the hydrogen fuel into one of the cylinders 116 for combustion. Combustion within the cylinders 116 is harnessed by pistons of the hydrogen internal combustion engine 102 and produces power.

While not shown in FIG. 1, it is understood that the hydrogen internal combustion engine system 100 includes various other components (e.g., valves, sensors, shafts, pulleys, radiator, etc.) that facilitate combustion of the hydrogen fuel and operation of the hydrogen internal combustion engine 102.

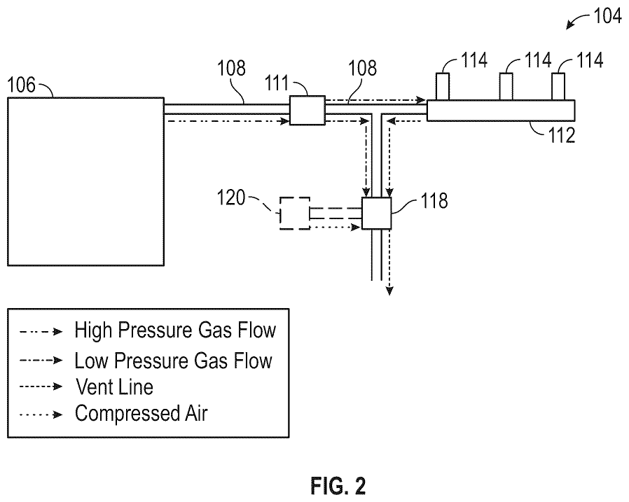

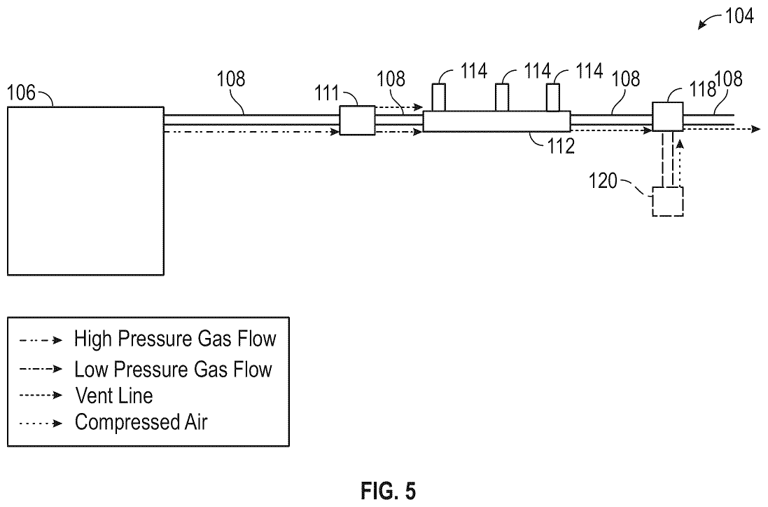

The hydrogen fuel system 104 also includes the vent valve 118 (e.g., relief valve, ball valve, manual valve, butterfly valve, pneumatic valve, solenoid valve, etc.). The vent valve 118 is fluidly coupled to one of the hydrogen fuel conduits 108. As is explained in greater detail herein, and illustrated specifically in FIGS. 2 and 5, the vent valve 118 may be variously located so as to tailor the hydrogen fuel system 104 to a particular application. For example, the vent valve 118 may be fluidly coupled to one of the hydrogen fuel conduits 108 that extends to the hydrogen fuel rail 112. Alternatively, the vent valve 118 may be fluidly coupled to the hydrogen fuel rail 112 (e.g., proximate an outlet of the hydrogen fuel rail 112, etc.).

The vent valve 118 is operable between a closed state (e.g., a non-venting state, a non-purging state, etc.) and an open state (e.g., a venting state, a purging state, etc.). When the vent valve 118 is in the open state, the vent valve 118 vents (e.g., releases, etc.) a portion of the hydrogen within the hydrogen fuel system 104 to atmosphere (e.g., to an environment surrounding the hydrogen internal combustion engine system 100, etc.). In this way, the vent valve 118 is utilized to vent hydrogen and depressurize the hydrogen fuel system 104. Venting and depressurizing the hydrogen fuel system 104 may be desirable at shutdown and/or during maintenance of the hydrogen internal combustion engine system 100. The vent valve 118 is also capable of purging the hydrogen fuel system 104 (e.g., purging the hydrogen from the hydrogen fuel system 104, etc.) when in the open state.

By venting the hydrogen using the vent valve 118, the hydrogen internal combustion engine system 100 may be capable of accommodating long shut-down periods and may also be capable of maintaining operation for prolonged periods of time, such as during contingency operation. Additionally, venting the hydrogen using the vent valve 118 mitigates leakage of the hydrogen from the hydrogen fuel system 104 (e.g., unintended leakage of hydrogen from components of the hydrogen fuel system 104, etc.), which makes the hydrogen internal combustion engine system 100 more desirable than other systems which do not vent hydrogen. During venting, low pressure hydrogen may be provided to the hydrogen fuel injectors 114 while high pressure hydrogen is vented. This enables operation of the hydrogen internal combustion engine 102 to be maintained during venting.

As is discussed in more detail herein, the vent valve 118 may be transitioned between the closed state and the open state in various ways. For example, the vent valve 118 may be manually operated (e.g., by a user, etc.) so as to transition between the closed state and the open state. The vent valve 118 may instead be pneumatically operated (e.g., using pneumatic pressure, using air pressure from the compressed air pump 120, etc.) so as to transition between the closed state and the open state. In another example, the vent valve 118 may be electronically operated (e.g., by the controller 122, etc.) so as to transition between the closed state and the open state.

In various embodiments, the hydrogen fuel system 104 also includes a compressed air pump 120 (e.g., air compressor, etc.). The compressed air pump 120 is fluidly coupled to the vent valve 118 (e.g., via an air conduit.). In these embodiments, compressed air from the compressed air pump 120 is utilized to transition the vent valve between the closed state and the open state. In other embodiments, the hydrogen fuel system 104 does not include the compressed air pump 120.

The controller 122 includes a processing circuit 124. The processing circuit 124 includes a processor 126. The processing circuit 124 also includes a memory 128. In various embodiments, the controller 122 is communicable with the vent valve 118. In these embodiments, the controller 122 is configured to cause the vent valve 118 to transition between the closed state and the open state (e.g., to vent the hydrogen, etc.). In embodiments where the compressed air pump 120 is included, the controller 122 is communicable with the compressed air pump 120 and configured to cause the vent valve 118 to transition between the closed state and the open state (e.g., to vent the hydrogen, etc.) using the compressed air pump 120. When the vent valve 118 is in the open state, venting of the hydrogen occurs until pressure of the hydrogen is equal to atmospheric pressure or until the vent valve 118 is transitioned from the open state to the closed state.

FIG. 2 illustrates the hydrogen fuel system 104 according to an embodiment. In this embodiment, the vent valve 118 is fluidly coupled to one of the hydrogen fuel conduits 108 that extends between the hydrogen fuel source 106 and the hydrogen fuel rail 112. As a result, the vent valve 118 is capable of venting the hydrogen upstream of the hydrogen fuel rail 112. In various embodiments, the compressed air pump 120 is included and is fluidly coupled to the vent valve 118. In other embodiments, the compressed air pump 120 is not included.

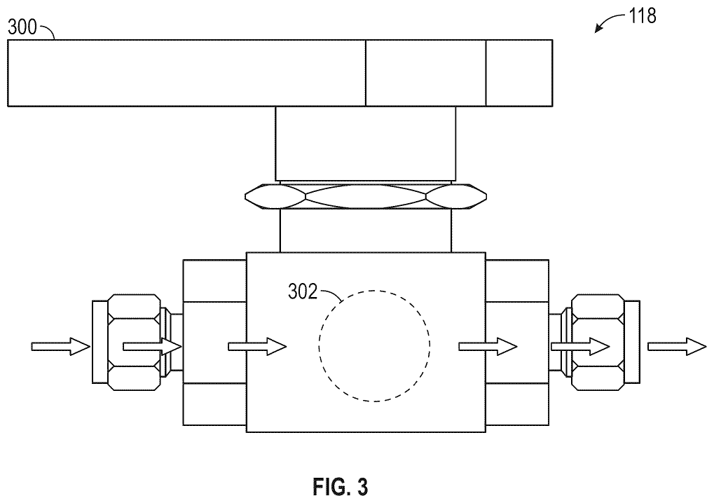

FIG. 3 illustrates the vent valve 118 being a manually operated valve. The vent valve 118 includes a lever 300 (e.g., a handle, etc.). The lever 300 is manually operated to open an internal mechanism 302 (e.g., ball, disc, etc.) of the vent valve 118. For example, the lever 300 may be coupled to the internal mechanism 302 such that manual operation of the lever 300 selectively adjusts the internal mechanism 302 to transition the vent valve 118 between the open state and the closed state. The internal mechanism 302 selectively provides a path for trapped hydrogen in the hydrogen fuel rail 112 and/or the hydrogen fuel conduits 108 to atmosphere. For example, an operator of the hydrogen internal combustion engine system 100 may manually operate the lever 300 to open the internal mechanism 302 to provide the path for the hydrogen within the hydrogen fuel rail 112 and/or the hydrogen fuel conduits 108 to the surroundings of the hydrogen internal combustion engine system 100.

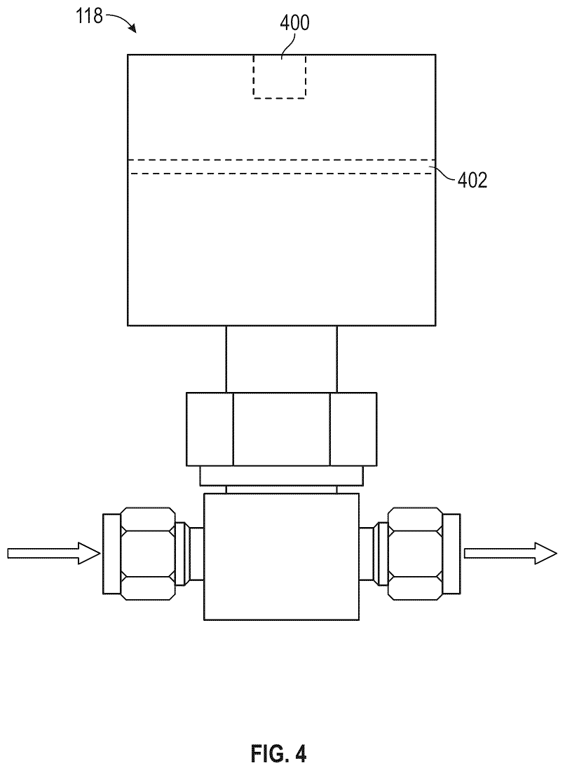

FIG. 4 illustrates the vent valve 118 being a pneumatically-actuated valve. The vent valve 118 includes a compressed air inlet 400. The compressed air inlet 400 is fluidly coupled to the compressed air pump 120 and is configured to receive compressed air from the compressed air pump 120. The vent valve 118 also includes an internal mechanism 402 (e.g., diaphragm, etc.). The internal mechanism 402 is selectively activated (e.g., lifted, etc.) by the compressed air which causes the vent valve 118 to transition from the closed state to the open state by opening a valve seat and providing a path for trapped hydrogen in the hydrogen fuel rail 112 and/or the hydrogen fuel conduits 108 to atmosphere. For example, the controller 122 may operate the compressed air pump 120 to provide the compressed air to the compressed air inlet 400 to selectively activate the internal mechanism 402 from the closed state to the open state to provide the path for the hydrogen within the hydrogen fuel rail 112 and/or the hydrogen fuel conduits 108 to the surroundings of the hydrogen internal combustion engine system 100. In some embodiments, the vent valve 118 is biased towards the closed state such that the vent valve 118 returns to the closed state when the internal mechanism 402 is no longer being selectively activated by the compressed air received from the compressed air pump 120.

FIG. 5 illustrates the hydrogen fuel system 104 according to an embodiment. In this embodiment, the vent valve 118 is fluidly coupled to the hydrogen fuel rail 112. As a result, the vent valve 118 is capable of venting the hydrogen within the hydrogen fuel rail 112. In various embodiments, the compressed air pump 120 is included and is fluidly coupled to the vent valve 118. In other embodiments, the compressed air pump 120 is not included.

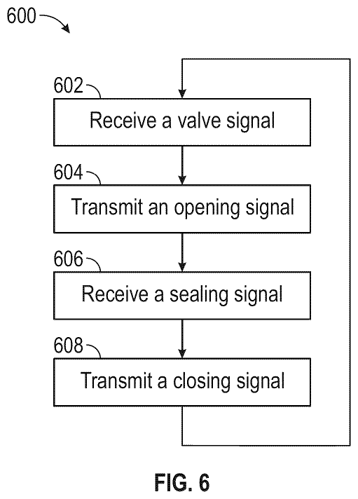

FIG. 6 illustrates a method 600 of operating the vent valve 118 by the controller 122. The method 600 includes, in block 602, receiving, by the controller 122, a valve signal. The valve signal may be transmitted to the controller 122 by an engine control unit (ECU) of the hydrogen internal combustion engine system 100, for example. Additionally or alternatively, the valve signal may be transmitted to the controller 122 by a mobile device (e.g., phone, tablet, laptop, etc.) or network (e.g., a wireless network, etc.).

The method 600 also includes, in block 604, transmitting, by the controller 122, an opening signal (e.g., a first control signal, etc.) corresponding to transitioning the vent valve 118 from the closed state to the open state after receiving the valve signal. For example, the controller 122 may transmit the opening signal responsive to receiving the valve signal. In response to the opening signal, the vent valve 118 is transitioned from the closed state to the open state. For example, the controller 122 may transmit the opening signal to the compressed air pump 120 to cause the compressed air pump 120 to provide compressed air to the vent valve 118 to transition the vent valve 118 from the closed state to the open state. In another example, the controller 122 may transmit the opening signal to the vent valve 118 such that the vent valve 118 itself may be caused to transition from the closed state to the open state (e.g., where the vent valve 118 is an electropneumatic valve, etc.). After the vent valve 118 is opened, the hydrogen is vented from the hydrogen fuel system 104.

The method 600 includes, in block 606, receiving, by the controller 122, a sealing signal (e.g., a second control signal, etc.) after transmitting the opening signal. The sealing signal may be transmitted to the controller 122 by the ECU of the hydrogen internal combustion engine system 100, for example. Additionally or alternatively, the sealing signal may be transmitted to the controller 122 by a mobile device (e.g., phone, tablet, laptop, etc.) or network. The sealing signal may be transmitted to the controller 122 upon start-up of the hydrogen internal combustion engine system 100 (e.g., by the ECU, etc.).

The method 600 also includes, in block 608, transmitting, by the controller 122, a closing signal corresponding to transitioning the vent valve 118 from the open state to the closed state after receiving the sealing signal. For example, the controller 122 may transmit the closing signal responsive to receiving the sealing signal. In response to the closing signal, the vent valve 118 is transitioned from the open state to the closed state. For example, the controller 122 may transmit the closing signal to the compressed air pump 120 to cause the compressed air pump 120 to cease providing compressed air to the vent valve 118 to transition the vent valve 118 from the open state to the closed state. In another example, the controller 122 may transmit the closing signal to the vent valve 118 such that the vent valve 118 itself may be caused to transition from the open state to the closed state (e.g., where the vent valve 118 is an electropneumatic valve, etc.). After the vent valve 118 is closed, the hydrogen is no longer vented from the hydrogen fuel system 104. The method 600 may then return to block 602.

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, “generally” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the appended claims.

The term “coupled” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

It is important to note that the construction and arrangement of the various systems shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the disclosure, the scope being defined by the claims that follow. When the language “a portion” is used, the item can include a portion and/or the entire item unless specifically stated to the contrary.

Any references herein to the positions of elements are merely used to describe the orientation of various elements in the FIGURES. It should be noted that the orientation of various elements may differ according to other exemplary embodiments, and that such variations are intended to be encompassed by the present disclosure.

Also, the term “or” is used, in the context of a list of elements, in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

What is claimed is:

1. A hydrogen fuel system comprising:
a hydrogen fuel conduit;
a hydrogen fuel rail in fluid communication with the hydrogen fuel conduit; and
a vent valve in fluid communication with at least one of the hydrogen fuel conduit or the hydrogen fuel rail, the vent valve configured to selectively transition between an open state and a closed state, the open state facilitating at least one of venting or purging of the hydrogen fuel system.

2. The hydrogen fuel system of claim 1, wherein the vent valve is in fluid communication with the hydrogen fuel conduit upstream of the hydrogen fuel rail.

3. The hydrogen fuel system of claim 2, further comprising:
a pressure regulator in fluid communication with the hydrogen fuel conduit,
wherein the vent valve is in fluid communication with the hydrogen fuel conduit downstream of the pressure regulator.

4. The hydrogen fuel system of claim 1, wherein the vent valve is in fluid communication with the hydrogen fuel rail downstream of the hydrogen fuel conduit.

5. A hydrogen internal combustion engine system comprising:
the hydrogen fuel system of claim 1; and
a hydrogen internal combustion engine;
wherein the hydrogen fuel rail is coupled to the hydrogen internal combustion engine.

6. A hydrogen internal combustion engine system comprising:
the hydrogen fuel system of claim 1; and
a hydrogen fuel source configured to contain hydrogen;
wherein the hydrogen fuel conduit is in fluid communication with the hydrogen fuel source such that the hydrogen fuel conduit receives the hydrogen from the hydrogen fuel source.

7. The hydrogen fuel system of claim 1, further comprising a compressed air pump fluidly coupled to the vent valve, the compressed air pump configured to selectively provide compressed air to the vent valve to transition the vent valve between the open state and the closed state.

8. The hydrogen fuel system of claim 7, further comprising a controller communicable with the vent valve, the controller configured to:
receive a valve signal; and
responsive to receiving the valve signal, transmit, to the compressed air pump, an opening signal such that the vent valve is transitioned from the closed state to the open state.

9. A hydrogen internal combustion engine system comprising:
the hydrogen fuel system of claim 8;
a hydrogen internal combustion engine coupled to the hydrogen fuel system; and
an engine control unit configured to control the hydrogen internal combustion engine,
wherein the controller receives the valve signal from the engine control unit.

10. The hydrogen fuel system of claim 8, wherein the controller is configured to:
receive a sealing signal; and
responsive to receiving the sealing signal, transmit, to the compressed air pump, a closing signal such that the vent valve is transitioned from the open state to the closed state.

11. The hydrogen fuel system of claim 1, further comprising a controller communicable with the vent valve, the controller configured to cause the vent valve to transition between the open state and the closed state,
wherein the vent valve is an electropneumatic valve.

12. The hydrogen fuel system of claim 11, wherein the controller is configured to:
receive a valve signal; and
responsive to receiving the valve signal, transmit, to the vent valve, an opening signal such that the vent valve is transitioned from the closed state to the open state.

13. A hydrogen internal combustion engine system comprising:
the hydrogen fuel system of claim 12;
a hydrogen internal combustion engine coupled to the hydrogen fuel system; and
an engine control unit configured to control the hydrogen internal combustion engine,
wherein the controller receives the valve signal from the engine control unit.

14. The hydrogen fuel system of claim 12, wherein the controller is configured to:
receive a sealing signal; and
responsive to receiving the sealing signal, transmit, to the vent valve, a closing signal such that the vent valve is transitioned from the open state to the closed state.

15. The hydrogen fuel system of claim 1, wherein the vent valve comprises a lever configured to be manually operated by an operator of the hydrogen fuel system to transition the vent valve between the open state and the closed state.

16. The hydrogen fuel system of claim 15, wherein the vent valve comprises an internal mechanism coupled to the lever, the internal mechanism configured to be adjusted by the lever such that the internal mechanism selectively provides a path through the vent valve when the vent valve is in the open state.

17. A method for operating a hydrogen fuel system, the method comprising:
receiving a valve signal; and
responsive to receiving the valve signal, transmitting, to a component of the hydrogen fuel system, an opening signal that causes a vent valve of the hydrogen fuel system to transition from a closed state to an open state, the open state facilitating at least one of venting or purging of the hydrogen fuel system.

18. The method of claim 17, further comprising:
receiving the valve signal from an engine control unit configured to control a hydrogen combustion engine coupled to the hydrogen fuel system.

19. The method of claim 17, further comprising:
receiving a sealing signal; and
responsive to receiving the sealing signal, transmitting, to the component, a closing signal that causes the vent valve to transition from the open state to the closed state.

20. The method of claim 19, further comprising:
receiving the valve signal from an engine control unit configured to control a hydrogen combustion engine coupled to the hydrogen fuel system; and
receiving the sealing signal from the engine control unit upon start-up of the hydrogen combustion engine.
